(19) United States
(12) Patent Application Publication
(10) Pub. No.: US 2023/0337122 A1
(43) Pub. Date: Oct. 19, 2023

(54) CORE NETWORK NODE, USER EQUIPMENT, AND METHODS THEREFOR

(71) Applicant: NEC Corporation, Minato-ku, Tokyo (JP)

(72) Inventors: Toshiyuki TAMURA, Tokyo (JP); Tsuyoshi TAKAKURA, Tokyo (JP)

(73) Assignee: NEC Corporation, Minato-ku, Tokyo (JP)

(21) Appl. No.: 18/027,832

(22) PCT Filed: Jul. 9, 2021
(86) PCT No.: PCT/JP2021/025972

§ 371 Date: Mar. 22, 2023

(30) Foreign Application Priority Data
Oct. 2, 2020 (JP) 2020-167941

(51) Int. Cl. H04W 48/18; H04W 60/04

(52) U.S. Cl. CPC H04W 48/18; H04W 60/04; H04W 84/042

(57) ABSTRACT

A core network node (3) stores a first association between a plurality of Home PLMN S-NSSAIs and a Serving PLMN S-NSSAI. The first association includes a second association between the Serving PLMN S-NSSAI and a Home PLMN S-NSSAI that is not subject to NSSAA, and a third association between the Serving PLMN S-NSSAI and another Home PLMN S-NSSAI subject to NSSAA. If a UE (1) does not support NSSAA feature and if a part of multiple Home PLMN S-NSSAIs presented by the UE (1) is included in the second association and the rest is included in the third association, the core network node sends information containing the second association to the UE (1). This can allow, for example, proper notification of information about a Mapped S-NSSAI available to a UE that does not support NSSAA.

### TECHNICAL FIELD

The present disclosure relates to radio communication networks, and in particular to the management of network slices allowed for radio terminals.

### BACKGROUND ART

The 5G system (5GS) supports network slicing (see for example Non-Patent Literature 1 to 3, especially Section 5.15 of Non-Patent Literature 1). Network slicing uses Network Function Virtualization (NFV) and software-defined networking (SDN) technologies to create multiple virtualized logical networks on top of physical networks. Each virtualized logical network is called a network slice. A network slices provides specific network capabilities and network characteristics. In order to form a single network slice, a network slice instance (NSI) is defined as a set of network function (NF) instances, resources (e.g., computer processing resources, storage, and networking resources), and an access network (AN) (one or both of a Next Generation Radio Access Network (NG-RAN) and a Non-3GPP Interworking Function (N3IWF)).

A network slice is identified by an identifier known as Single Network Slice Selection Assistance Information (S-NSSAI). The S-NSSAI consists of a Slice/Service type (SST) and a Slice Differentiator (SD). The SST refers to the expected network slice behaviour in terms of features and services. The SD is optional information and complements the SST to differentiate amongst multiple network slices of the same Slice/Service type.

An S-NSSAI can have standard values or non-standard values. Currently, standard SST values 1, 2, 3, and 4 are associated respectively with enhanced Mobile Broad Band (eMBB), Ultra-Reliable and Low-Latency Communication (URLLC), Massive Internet of Things (MIoT), and Vehicle to Everything (V2X) slice types. Anon-standard value of an S-NSSAI with identifies a single network slice within a specific Public Land Mobile Network (PLMN). In other words, non-standard values are PLMN-specific values, and associated with the PLMN ID of a PLMN that has assigned them. Each S-NSSAI assists a network in selecting a particular NSI. A NSI may be selected via different S-NSSAIs. An S-NSSAI may be associated with different NSIs. A network slice may be uniquely identified by an S-NSSAI.

There are two types of S-NSSAI, which are known as S-NSSAI and Mapped S-NSSAI. An S-NSSAI identifies a network slice provided by the Serving Public Land Mobile Network (Serving PLMN) in which the User Equipment (UE) is registered, and may be referred to in this specification as Serving PLMN S-NSSAI. A Mapped S-NSSAI may be a Home PLMN (HPLMN) S-NSSAI that is mapped to (or is associated with, or is in combination with, or corresponds to) an S-NSSAI identifying a network slice of the roaming network when the UE is roaming, and may also be an S-NSSAI included in the UE user's subscription information among them. Hereafter, S-NSSAI and Mapped S-NSSAI may be referred to collectively as simply S-NSSAI in this specification.

Meanwhile, Network Slice Selection Assistance Information (NSSAI) means a set of S-NSSAIs. Accordingly, one or more S-NSSAIs can be included in one NSSAI. There are multiple types of NSSAI, known as Configured NSSAI, Requested NSSAI, Allowed NSSAI, Rejected NSSAI, and Pending NSSAI.

Configured NSSAI includes one or more S-NSSAIs each applicable to one or more PLMNs. For example, The Configured NSSAI is configured by a Serving PLMN and is applied to the Serving PLMN. In addition, a Serving PLMN S-NSSAI included in a Configured NSSAI may have one or more Mapped S-NSSAIs associated therewith. Alternatively, the Configured NSSAI may be a Default Configured NSSAI. The Default Configured NSSAI is configured by the Home PLMN (HPLMN) and applies to any PLMNs for which no specific Configured NSSAI has been provided. For example, a radio terminal (User Equipment (UE)) is provisioned with the Default Configured NSSAI from a Unified Data Management (UDM) of the HPLMN via an Access and Mobility Management Function (AMF).

Allowed NSSAI is provided to a UE by a Serving PLMN and indicates one or more S-NSSAIs that the UE can use in the current registration area of the Serving PLMN. The Allowed NSSAI is determined by an AMF of the Serving PLMN during, for example, a registration procedure. The Allowed NSSAI is signaled to the UE by the network (i.e., AMF) and stored in memories (e.g., non-volatile memories) of both the AMF and the UE.

Rejected NSSAI includes one or more S-NSSAIs rejected by the current PLMN. The Rejected NSSAI may be referred to as rejected S-NSSAIs. An S-NSSAI is rejected throughout the current PLMN or rejected in the current registration area. If an AMF rejects any of one or more S-NSSAIs included in the Requested NSSAI, for example, in a registration procedure of a UE, the AMF includes them in the Rejected NSSAI. The Rejected NSSAI is signaled to the UE by the network (i.e., AMF) and stored in (non-volatile) memories of both the AMF and the UE.

Pending NSSAI indicates one or more S-NSSAIs for which Network Slice-Specific Authentication and Authorization (NSSAA) is pending. A Serving PLMN needs to perform NSSAA for S-NSSAI(s) of the HPLMN which are subject to NSSAA based on subscription information. In order to perform NSSAA, an AMF invokes an Extensible Authentication Protocol (EAP)-based authorization procedure. The EAP-based authentication procedure takes a relatively long time to obtain its outcome. Accordingly, whilst the AMF determines Allowed NSSAI as described above during a registration procedure of a UE, it does not include S-NSSAI(s) subject to NSSAA in the Allowed NSSAI, but instead them in the Pending NSSAI. The Pending NSSAI is signaled to the UE by the network (i.e., AMF) and stored in (non-volatile) memories of both the AMF and the UE.

An AMF manages a UE context for a UE in the Registration Management (RM)-REGISTERED state. The UE context may be referred to as, but is not limited to, a Mobility Management (MM) context. The UE context may include one or more of the Allowed NSSAI, Rejected NSSAI, and Pending NSSAI described above. On the other hand, the UE manages a UE NSSAI configuration. The UE NSSAI configuration includes the Configured NSSAI, Allowed NSSAI, Rejected NSSAI, and Pending NSSAI described above. The UE NSSAI configuration is stored in non-volatile memory in the UE (Mobile Equipment (ME) excluding a Universal Subscriber identity Module (USIM)). The memory or memory area in which the UE NSSAI configuration is stored is referred to as NSSAI storage.

A Requested NSSAI information element (IE) is signaled to a network by a UE, for example in a registration procedure, allowing the network to determine the Serving AMF, one or more network slices and one or more NSIs for that UE.

A Requested mapped NSSAI information element (IE) is an information element included in a Registration Request message sent to a network by a UE that has no information about S-NSSAI (Serving PLMN S-NSSAI). This information element includes one or more Mapped S-NSSAIs held by the UE. Unlike the Requested NSSAI IE, which contains both a Serving PLMN S-NSSAI and Mapped S-NSSAI(s) associated therewith, the Requested mapped NSSAI IE contains only Mapped S-NSSAI(s).

Thereafter, Registration Request messages in this specification may be Registration Request messages for Initial Registration, or for Mobility Registration Update, or for Periodic Registration Update.

### CITATION LIST

### Non Patent Literature

[Non-Patent Literature 1] 3GPP TS 23.501 V16.5.1 (2020 August) “3rd Generation Partnership Project; Technical Specification Group Services and System Aspects; System Architecture for the 5G System (5GS); Stage 2 (Release 16)”, August 2020
[Non-Patent Literature 22] 3GPP TS 23.502 V16.5.1 (2020 August) “3rd Generation Partnership Project; Technical Specification Group Services and System Aspects; Procedures for the 5G System (5GS); Stage 2 (Release 16)”, August 2020
[Non-Patent Literature 3] 3GPP TS 24.501 V16.5.1 (2020 July) “3rd Generation Partnership Project; Technical Specification Group Core Network and Terminals; Non-Access-Stratum (NAS) protocol for 5G System (5GS); Stage 3 (Release 16)”, July 2020
[Non-Patent Literature 4] OPPO, “NSSAA Slice handling for 1-to-many mapping in roaming scenario”, C1-205232, 3GPP TSG-CT WG1 Meeting #125-e, Electronic meeting, 20-28 Aug. 2020

### SUMMARY OF INVENTION

### Technical Problem

In a roaming scenario, multiple Mapped S-NSSAIs (i.e., Home PLMN (HPLMN) S-NSSAIs) may be associated with a single Serving PLMN S-NSSAI. In addition, only a subset of these multiple Mapped S-NSSAIs may be subject to Network Slice-Specific Authentication and Authorization (NSSAA). In this case, for example, an AMF may receive a Registration Request from a UE that does not support NSSAA, containing a Mapped S-NSSAI subject to NSSAA and a Mapped S-NSSAI not subject to NSSAA, and these two Mapped S-NSSAIs may be mapped to (or associated with) the same Serving PLMN S-NSSAI, but it is not clear how the AMF would inform the UE that one of the two Mapped S-NSSAIs is not available.

One of the objects to be attained by embodiments disclosed herein is to provide apparatuses, methods, and programs that contribute to enabling an AMF and a UE to properly perform notification of information about a Mapped S-NSSAI(s) available to the UE that does not support NSSAA when multiple Mapped S-NSSAIs are associated with a single Serving PLMN S-NSSAI. It should be noted that this object is merely one of the objects to be attained by the embodiments disclosed herein. Other objects or problems and novel features will be made apparent from the following description and the accompanying drawings.

### Solution to Problem

In a first aspect, a core network node includes at least one memory and at least one processor coupled to the at least one memory. The at least one processor is configured to store a first association between a plurality of Home PLMN S-NSSAIs and one Serving PLMN S-NSSAI. The first association includes a second association between the one Serving PLMN S-NSSAI and at least one Home PLMN S-NSSAI that is not subject to NSSAA, and a third association between the one Serving PLMN S-NSSAI and at least one Home PLMN S-NSSAI subject to NSSAA. The at least one processor is configured to receive information indicating whether an NSSAA feature is supported from a UE. The at least one processor is configured to, if the information indicates that the NSSAA feature is not supported, and if a part of multiple Home PLMN S-NSSAIs presented by the UE is included in the second association and the rest is included in the third association, send information including the second association out of the first association to the UE.

In a second aspect, a UE includes at least one memory and at least one processor coupled to the at least one memory. The at least one processor is configured to send information to a core network node indicating whether an NSSAA feature is supported and receive a Non-Access Stratum (NAS) message from the core network node. If the information indicates that the NSSAA feature is not supported, the NAS message contains a second association of one Serving PLMN S-NSSAI with at least one first Home PLMN S-NSSAI not subject to NSSAA and contains a third association of the one Serving PLMN S-NSSAI with at least one second Home PLMN S-NSSAI subject to NSSAA. The at least one processor is configured to, based on the second and third associations, update a stored NSSAI storage to make the at least one first Home PLMN S-NSSAI included in the second association available and to make the at least one second Home PLMN S-NSSAI included in the third association unavailable.

In a third aspect, a method performed by a core network node includes the steps of:
(a) storing a first association between a plurality of Home PLMN S-NSSAIs and one Serving PLMN S-NSSAI, wherein the first association includes a second association between the one Serving PLMN S-NSSAI and at least one Home PLMN S-NSSAI that is not subject to NSSAA, and a third association between the one Serving PLMN S-NSSAI and at least one Home PLMN S-NSSAI subject to NSSAA;
(b) receiving information indicating whether an NSSAA feature is supported from a UE; and
(c) if the information indicates that the NSSAA feature is not supported, and if a part of multiple Home PLMN S-NSSAIs presented by the UE is included in the second association and the rest is included in the third association, sending information including the second association out of the first association to the UE.

In a fourth aspect, a method performed by a UE includes the steps of:
(a) sending information to a core network node indicating whether an NSSAA feature is supported;
(b) receiving a NAS message from the core network node, wherein if the information indicates that the NSSAA feature is not supported, the NAS message contains a second association of one Serving Public Land Mobile Network (PLMN) Single Network Slice Selection Assistance Information (S-NSSAI) with at least one first Home PLMN S-NSSAI not subject to NSSAA and contains a third association of the one Serving PLMN S-NSSAI with at least one second Home PLMN S-NSSAI subject to NSSAA; and
(c) based on the second and third associations, updating a stored NSSAI storage to make the at least one first Home PLMN S-NSSAI included in the second association available and to make the at least one second Home PLMN S-NSSAI included in the third association unavailable.

In a fifth aspect, a program includes a set of instructions (software codes) that, when loaded into a computer, cause the computer to perform the method according to the third or fourth aspect described above.

### Advantageous Effects of Invention

According to the above-described aspects, it is possible to provide apparatuses, methods, and programs that contribute to enabling an AMF and a UE to properly perform notification of information about a Mapped S-NSSAI(s) available to the UE that does not support NSSAA when multiple Mapped S-NSSAIs are associated with a single Serving PLMN S-NSSAI.

### BRIEF DESCRIPTION OF DRAWINGS

FIG. 1 shows an example configuration of a radio communication network according to an embodiment;

FIG. 2 is a flowchart showing an example of an operation of an AMF according to an embodiment;

FIG. 3 is a sequence diagram showing an example of operations of a UE, an AMF, and an UDM according to an embodiment;

FIG. 4 is a flowchart showing an example of an operation of an AMF according to an embodiment;

FIG. 5 is a sequence diagram showing an example of operations of a UE, an AMF, and an UDM according to an embodiment;

FIG. 6 is a flowchart showing an example of an operation of a UE according to an embodiment;

FIG. 7 is a flowchart showing an example of an operation of a UE according to an embodiment;

FIG. 8 is a block diagram showing an example configuration of a UE according to an embodiment; and

FIG. 9 is a block diagram showing an example configuration of an AMF and a UDM according to an embodiment.

### EXAMPLE EMBODIMENT

Specific embodiments will be described hereinafter in detail with reference to the drawings. The same or corresponding elements are denoted by the same symbols throughout the drawings, and duplicated explanations are omitted as necessary for the sake of clarity.

Each of the embodiments described below may be used individually, or two or more of the embodiments may be appropriately combined with one another. These embodiments include novel features different from each other. Accordingly, these embodiments contribute to attaining objects or solving problems different from one another and contribute to obtaining advantages different from one another.

The following descriptions on the embodiments mainly focus on the 3GPP fifth generation mobile communication system (5G system (5GS)). However, these embodiments may be applied to other radio communication systems that support network slicing similar to that in 5GS.

### First Embodiment

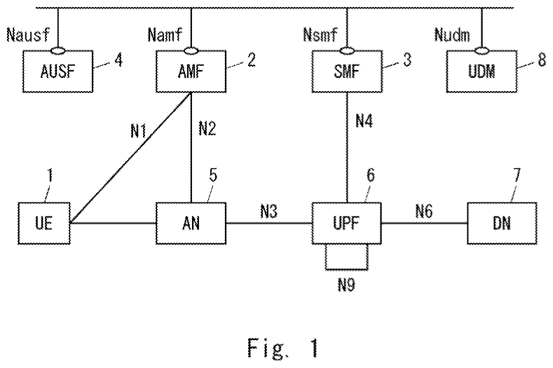

FIG. 1 shows an example configuration of a radio communication network (i.e., 5GS) according to this embodiment. Each of the elements shown in FIG. 1 is a network function and provides an interface as defined by the 3rd Generation Partnership Project (3GPP). Each of the elements (network functions) shown in FIG. 1 can be implemented, for example, as a network element on dedicated hardware, as a software instance running on dedicated hardware, or as a virtual function instantiated on an application platform.

The radio communication network shown in FIG. 1 may be provided by a Mobile Network Operator (MNO), or it may be a Non-Public Network (NPN) provided by a non-MNO. If the radio communication network shown in FIG. 1 is an NPN, it may be an independent network, called a Stand-alone Non-Public Network (SNPN), or it may be an NPN in conjunction with an MNO network, called a public network integrated NPN.

A radio terminal (i.e., UE) 1 communicates with a data network (DN) 7 using the 5G connectivity service. More specifically, the UE 1 is connected to an access network (i.e., 5G Access Network (SGAN)) 5 and communicates with the data network (DN) 7 via a User Plane Function (UPF) 6 in a core network (i.e., 5G core network (5GC)). The AN 5 may include a Next Generation Radio Access Network (NG-RAN) or a non-3GPP AN, or both. The Non-3GPP AN may be a network that handles wireless LAN (WiFi) communication or a network that handles wired communication, known as a Wireline 5G Access Network (W-SGAN). The UPF 6 may include multiple UPFs that are interconnected.

In the 5G architecture, the connectivity service between the UE 1 and the DN 7 is supported by one or more Protocol Data Unit (PDU) Sessions. A PDU Session is an association, session, or connection between the UE 1 and the DN7. A PDU Session is used to provide a PDU connectivity service (i.e., an exchange of PDUs between the UE 1 and the DN 7). The UE 1 establishes one or more PDU Sessions between the UE 1 and the UPF 6 (i.e., the PDU Session anchor) to which the DN 7 is connected. From a data transfer perspective, a PDU Session consists of a tunnel (N9 tunnel) in the 5GC, a tunnel (N3 tunnel) between the 5GC and the AN 5, and one or more radio bearers. Although not shown in FIG. 1, the UE 1 may establish multiple PDU Sessions with multiple UPFs (PDU Session anchors) 6 to access multiple DNs 7 concurrently.

The AMF 2 is a network function within the 5GC Control Plane. The AMF 2 provides termination of a RAN Control Plane (CP) interface (i.e., N2 interface). The AMF 2 terminates a single signalling connection (i.e., N1 NAS signalling connection) with the UE 1 and provides registration management, connection management, and mobility management. The AMF 2 provides NF services on a service-based interface (i.e., Namf interface) to NF consumers (e.g., other AMFs, Session Management Function (SMF) 3, and Authentication Server Function (AUSF) 4). The NF services provided by the AMF 2 include a communication service (Namf_Communication). The communication service allows NF consumers (e.g., SMF 3) to communicate with the UE 1 or the AN 5 via the AMF 2.

The SMF 3 is a network function within the 5GC Control Plane. The SMF 3 manages PDU Sessions. The SMF 3 sends and receives SM signalling messages (NAS-SM messages, N1 SM messages) to and from the Non-Access-Stratum (NAS) Session Management (SM) layer of the UE 1 via the communication service provided by the AMF 2. The SMF 3 provides NF services on a service-based interface (i.e., Nsmf interface) to NF consumers (e.g., AMF 2, other SMFs). The NF services provided by the SMF 3 include a PDU Session management service (Nsmf_PDUSession), which allows NF consumers (e.g., AMF 2) to handle PDU Sessions. The SMF 3 may be an Intermediate SMF (I-SMF). The I-SMF is inserted between the AMF 2 and an original SMF as needed when the UPF 6 belongs to a different SMF service area and cannot be controlled by the original SMF.

The AUSF 4 is a network function within the 5GC Control Plane. The AUSF 4 provides NF services on a service based interface (i.e., Nausf interface) to NF consumers (e.g., AMF 2, UDM 8). The NF services provided by the AUSF 4 include a UE authentication service (e.g., Nausf_UEAuthentication and Nausf_NSSAA_Authenticate). The Nausf_UEAuthentication service provides UE authentication and related key information (keying material) to NF consumers (i.e., AMF). More specifically, the AUSF 4 cooperates with the UDM 8 and an Authentication credential Repository and Processing Function (ARPF) to perform authentication using one of the two authentication methods (i.e., 5G-Authentication and Key Agreement (AKA) and EAP-based authentication) supported by the 5GS. After performing the authentication, the AUSF 4 replies to the AMF 2 with the authentication result and, if successful, a master key. The master key is used by the AMF 2 to derive NAS security keys and other security key(s). For UE authentication, the AUSF 4 works closely with the UDM 8. The Nausf_NSSAA_Authenticate service provides NF consumers (e.g., AMF 2) with a Network Slice-Specific Authentication and Authorization service between the UE 1 and an AAA server via the AUSF 4.

The UDM 8 is a network function within the 5GC Control Plane. The UDM 8 provides access to a database (i.e., User Data Repository (UDR)) containing subscriber data (or subscription information). The UDM 8 provides NF services on a service-based interface (i.e., Nudm interface) to NF consumers (e.g., AMF 2, AUSF 4, SMF 3). The NF services provided by the UDM 8 include a subscriber data management service. This NF service allows NF consumers (e.g., AMF 2) to retrieve subscriber data, and provides updated subscriber data to NF consumers.

The example configuration in FIG. 1 shows only some major NFs for illustrative purposes. The radio communication network in this embodiment may be configured specifically for roaming (see, for example, Section 4.2.4 of Non-Patent Literature 1) and may include other NFs not shown in FIG. 1, such as Network Slice Selection Function (NSSF) and a Policy Control Function (PCF).

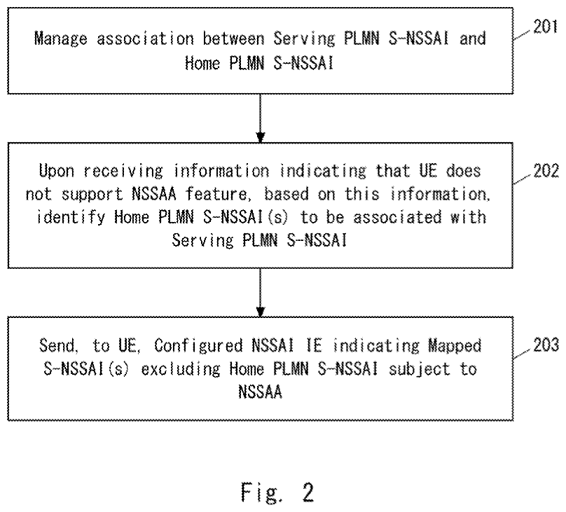

FIG. 2 is a flowchart showing an example of the operation of the AMF 2 according to this embodiment. In step 201, the AMF 2 manages (or stores) associations between Serving PLMN S-NSSAIs and Mapped S-NSSAIs (or HPLMN S-NSSAIs). In these associations, one or more Mapped S-NSSAIs may be associated with a single Serving PLMN S-NSSAI. These one or more Mapped S-NSSAIs may be S-NSSAIs of another PLMN (the HPLMN of the UE 1) that is different from the PLMN to which the AMF 2 belongs. Hereinafter, such an association is referred to in this specification as first association. In the first association, at least one Mapped S-NSSAI subject to Network Slice-Specific Authentication and Authorization (NSSAA) and at least one Mapped S-NSSAI not subject to NSSAA are both associated with one Serving PLMN S-NSSAI.

In step 202, the AMF 2 receives a Registration Request message from the UE 1 containing information indicating whether the UE 1 supports the NSSAA feature. Based on this information, the AMF 2 identifies (or determines) a Mapped S-NSSAI(s) to be associated with a Serving PLMN S-NSSAI. More specifically, the AMF 2 may determine whether or not the UE 1 supports the NSSAA feature based on 5th generation mobility management (5GMM) Capability information regarding NSSAA contained in the received Registration Request message. The 5GMM Capability information about NSSAA indicates whether the UE 1 supports the NSSAA feature. The 5GMM Capability information about NSSAA may be a Network slice-specific authentication and authorization (NSSAA) value included in the 5GMM Capability information. The NSSAA value is an example of information indicating whether NSSAA feature is supported. The AMF 2 may recognize that the UE 1 does not support the NSSAA feature if the NSSAA value indicates “Network slice-specific authentication and authorization not supported” or if the NSSAI value is not included in the 5GMM Capability information. The AMF 2 then refers to the first association between the Serving PLMN S-NSSAI and multiple Mapped S-NSSAIs, and identifies (or selects) the Serving PLMN S-NSSAI and at least one Mapped S-NSSAI associated with that Serving PLMN S-NSSAI and not subject to NSSAA.

In step 203, the AMF 2 sets, out of the first association, an association of the Serving PLMN S-NSSAI with at least one Mapped S-NSSAI not subject to NSSAA (hereafter this association is referred to as the second association) into a Configured NSSAI Information Element (IE) for the UE 1. The AMF 2 then sends the Configured NSSAI IE to the UE 1. In other words, the AMF 2 selects S-NSSAI(s) that are not subject to NSSAA as Mapped S-NSSAI(s) to be associated with the Serving PLMN S-NSSAI, but does not adopt S-NSSAI(s) subject to NSSAA into the Mapped S-NSSAI(s). This means that the AMF 2 excludes S-NSSAI(s) subject to NSSAA from one or more Mapped S-NSSAIs to be associated with the Serving PLMN S-NSSAI. In this way, the AMF 2 excludes Mapped S-NSSAI(s) subject to NSSAA from the Configured NSSAI for the UE 1.

The AMF 2 may send the Configured NSSAI IE to the UE 1 via a message sent from the AMF 2 to the UE 1 to configure or update the NSSAI Storage or other UE configurations. This message may be a NAS message, or more specifically, a Registration Accept message. In response to receiving this message, the UE 1 updates the NSSAI Storage stored in a memory of the UE 1. Specifically, the UE 1 deletes or removes all the S-NSSAIs stored in the Configured NSSAI in the NSSAI storage and then stores the S-NSSAI(s) contained in the received Configured NSSAI IE, or the UE 1 replaces or rewrites the Configured NSSAI in the NSSAI storage by the S-NSSAI(s) included in the received Configured NSSAI IE.

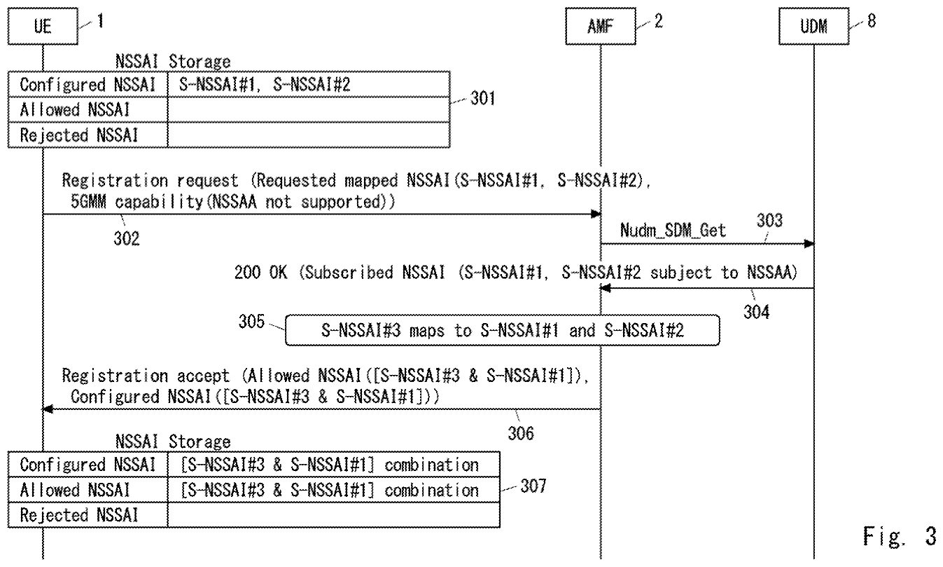

FIG. 3 shows an example of the procedure for updating the NSSAI Storage of the UE 1. In step 301, the Configured NSSAI in the NSSAI Storage of the UE1 stores Home PLMN S-NSSAIs (here S-NSSAI #1, S-NSSAI #2). In step 302, the UE 1 sends a Registration Request message to the AMF 2. The AMF 2 may be an AMF in a Visited PLMN (VPLMN). The UE 1 includes S-NSSAI #1 and 5-NSSAI #2 into a Requested mapped NSSAI IE contained in the Registration Request message, based on the stored Configured NSSAI. In addition, the Registration Request message indicates that the UE 1 does not support NSSAA. Specifically, the Registration Request message contains a 5GMM Capability IE set to “Network slice-specific authentication and authorization not supported”.

In step 303, the AMF 2 submits a resource request regarding the Subscribed NSSAI of the UE 1 using a Get operation to the Subscriber Data Management (SDM) service exposed by the UDM 8. The request may be made, for example, via a Nudm_SDM_Get Application Programming Interface (API). In step 304, the UDM 8 returns the Subscribed NSSAI (here S-NSSAI #1, S-NSSAI #2) of the UE 1 to the AMF 2, including it in the message body of a message with the status code 200 OK. The subscribed NSSAI has an AdditionalSnssaiData attribute (or field). This field indicates whether or not each S-NSSAI is subject to NSSAA. Specifically, the field contains a list of attribute (e.g., requiredAuthnAuthz) values, each of which indicates whether or not the corresponding S-NSSAI is subject to NSSAA. More specifically, the attribute value for S-NSSAI #1 indicates that 5-NSSAI #1 is not subject to NSSAA (e.g., requiredAuthnAuthz=false or absent), while the attribute value for S-NSSAI #2 indicates that S-NSSAI #2 is subject to NSSAA (e.g., requiredAuthnAuthz=true).

In step 305, the AMF 2 has associated a specific Serving PLMN S-NSSAI (here S-NSSAI #3) that the AMF 2 supports (or can serve) with S-NSSAI #1 and S-NSSAI #2. That is, two Mapped S-NSSAIs (5-NSSAI #1, S-NSSAI #2) are associated with S-NSSAI #3. The selection of a specific Serving PLMN S-NSSAI to be associated with S-NSSAI #1 and S-NSSAI #2 may be performed by the NSSF, for example. Specifically, after step 304, the AMF 2 may send S-NSSAI #1 and S-NSSAI #2 to the NSSF. Upon receipt of S-NSSAI #1 and S-NSSAI #2, the NSSF may associate S-NSSAI #1 and S-NSSAI #2 with a specific Serving PLMN S-NSSAI (in this case S-NSSAI #3) and may send this association (i.e., first association) to the AMF 2. The NSSF may send Configured NSSAI including this first association to the AMF 2, or send Allowed NSSAI including it to the AMF 2.

In step 306, the AMF 2 determines an Allowed NSSAI IE and a Configured NSSAI IE to be sent to the UE 1 based on the NSSAA value in the 5GMM Capability information indicating that the UE 1 does not support NSSAA (“Network slice-specific authentication and authorization not supported”). Specifically, the AMF 2 sets, in the Allowed NSSAI IE, a combination (or second association) of 5-NSSAI #3 and a Mapped S-NSSAI(s) (here, S-NSSAI #1) associated with S-NSSAI #3 and not subject to NSSAA. In addition, in order to update the Configured NSSAI in the NSSAI Storage of the UE 1, the AMF 2 sets, in the Configured NSSAI IE, a combination (or second association) of S-NSSAI #3 and a Mapped S-NSSAI(s) (here, 5-NSSAI #1) associated with S-NSSAI #3 and not subject to NSSAA. The AMF 2 sends a NAS message (e.g., Registration Accept message) containing these Allowed NSSAI IE and Configured NSSAI IE to the UE 1.

In step 307, upon receiving the NAS message, the UE 1 updates the NSSAI Storage stored in a memory of the UE 1. Specifically, the UE 1 deletes or removes all the S-NSSAIs stored in the Configured NSSAI of the NSSAI storage and then stores the S-NSSAI(s) contained in the received Configured NSSAI IE. Alternatively, the UE 1 replaces or rewrites the Configured NSSAI of the NSSAI storage with the 5-NSSAI(s) included in the received Configured NSSAI IE. That is, the UE 1 stores the combination (or second association) of S-NSSAI #3 and a Mapped S-NSSAI(s) not subject to NSSAA (here, S-NSSAI #1), which has been contained in the received Configured NSSAI IE, into its Configured NSSAI. The UE 1 may determine that S-NSSAI #2 is not available in the Serving PLMN based on the fact that the received Configured NSSAI IE contains no Serving PLMN S-NSSAI associated with S-NSSAI #2. In other words, UE 1 will not set S-NSSAI #2 in either the Requested mapped NSSAI IE or Requested NSSAI IE of a Registration Request message to be sent in this Serving PLMN after this point.

The UE 1 may also suppress the transmission of Registration Requests using the S-NSSAI in question (in this case, S-NSSAI #2) until the terminal is powered off and on or until the Universal Subscriber Identity Module (USIM) is removed and inserted. In other words, the UE 1 may keep the updated Configured NSSAI in the NSSAI Storage (here the Configured NSSAI with S-NSSAI #2 excluded) stored until the terminal is powered off and on or until the USIM is removed and inserted. However, in response to or subsequent to a change in the UE 1's NSSAA feature support status, the UE 1 may set S-NSSAI #2 in the Requested mapped NSSAI IE in a Registration Request message. This can happen, for example, when the USIM is inserted into a different Mobile Equipment (ME). In other words, the UE 1 may reset the Configured NSSAI in the updated NSSAI Storage (here the Configured NSSAI with S-NSSAI #2 excluded) in response to terminal power on/off or USIM removal/insertion. The UE 1 may reset the Configured NSSAI (here the Configured NSSAI with S-NSSAI #2 excluded) in the updated NSSAI Storage in response to a change in the support status of the NSSAA feature of the UE 1. After the reset, if the UE 1 receives a message (e.g., Registration Accept message) from the AMF 2 indicating that S-NSSAI #2 is to be included in the Configured NSSAI, it may set S-NSSAI #2 in the Requested mapped NSSAI IE in subsequent Registration Request messages.

In the example procedure for updating the NSSAI Storage of the UE 1 described above, the AMF 2 determines the Configured NSSAI IE to be sent to the UE 1 based on the NSSAA value of the 5GMM Capability information indicating that the UE 1 does not support NSSAA. In another example, the UDM 8 may be involved in this determination. Specifically, in step 304, the UDM 8 may return the subscribed NSSAI excluding S-NSSAI(s) subject to NSSAA (here 5-NSSAI #2) and including S-NSSAI(s) not subject to NSSAA (here 5-NSSAI #1) to the AMF 2, including it in the message body of a message with the status code 200 OK. As a result of the exclusion of S-NSSAI(s) subject to NSSAA from the Subscribed NSSAI, in step 305, the AMF 2 associates the Serving PLMN S-NSSAI (here S-NSSAI #3) with S-NSSAI #1. In other words, S-NSSAI #2 is not mapped to the Serving PLMN S-NSSAI (S-NSSAI #3). In step 306, the AMF 2 determines the Configured NSSAI IE based on the association in step 305. That is, in that other example, the UDM 8 determines the S-NSSAI(s) to be stored in the Configured NSSAI in the NSSAI Storage of the UE 1 based on information indicating that the UE 1 does not support NSSAA. The information indicating that the UE 1 does not support NSSAA may be the subscription information of the UE 1. Alternatively, this information may be information in the request in step 303 indicating that the UE 1 does not support NSSAA. The AMF 2 may set this into the request in step 303 based on the NSSAA value in the 5GMM Capability information indicating that the UE 1 does not support NSSAA.

The procedure in this embodiment updates the configuration (NSSAI Storage) in the UE 1 based on an association indicating an available Home PLMN slice service(s) (or Mapped S-NSSAI(s)) in roaming scenarios. This allows the UE 1 to properly select available slice services.

For example, in a roaming scenario, one Serving PLMN S-NSSAI may be associated with both a Mapped S-NSSAI(s) (or HPLMN S-NSSAI(s)) subject to NSSAA and a Mapped S-NSSAI(s) (or HPLMN S-NSSAI(s)) not subject to NSSAA. In this case, if the UE 1 does not support NSSAA, the AMF 2 in the Serving PLMN updates the Configured NSSAI in the NSSAI Storage of the UE 1 in a Registration procedure, thereby excluding (or removing, erasing) the Mapped S-NSSAI(s) subject to NSSAA from the Configured NSSAI. Specifically, the AMF 2 of the Serving PLMN includes the second association described above (i.e., the association between the Serving PLMN S-NSSAI and a Mapped S-NSSAI(s) not subject to NSSAA) in the Configured NSSAI IE in the Registration Accept message to be sent to the UE 1, but does not include any association between the Serving PLMN S-NSSAI and a Mapped S-NSSAI(s) subject to NSSAA. Based on the second association or the Mapped S-NSSAI(s) included in the received Configured NSSAI IE, the UE 1 that does not support NSSAA is able to exclude Mapped S-NSSAI(s) subject to NSSAA from the Configured NSSAI of the NSSAI Storage currently stored in the UE 1. Thus, the UE 1 can avoid setting Mapped S-NSSAI(s) subject to NSSAA in Registration Request messages in subsequent registration procedures.

### Second Embodiment

A configuration example of a radio communication network according to this embodiment may be the same as the example shown in FIG. 1. This embodiment provides another examples of associating a Serving PLMN S-NSSAI with a Mapped S-NSSAI(s) by the AMF 2 and updating the NSSAI Storage.

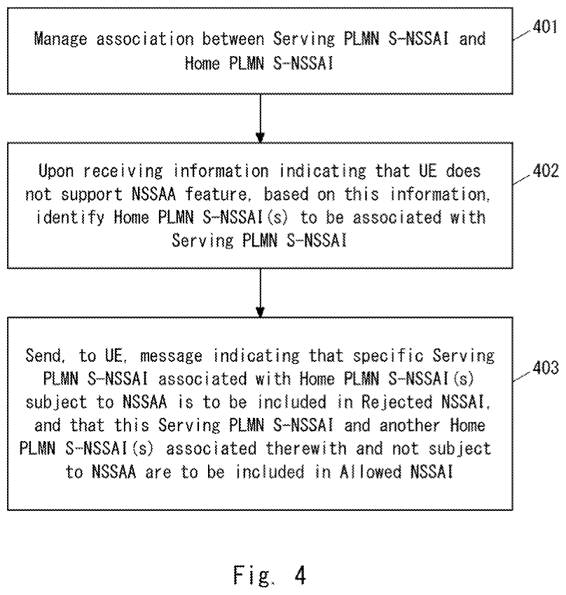

FIG. 4 is a flowchart showing an example of the operation of the AMF 2 according to this embodiment. In step 401, the AMF 2 manages (or stores) associations between Serving PLMN S-NSSAIs and Mapped S-NSSAIs (or HPLMN S-NSSAIs). In these associations, one or more Mapped S-NSSAIs may be associated with a single Serving PLMN S-NSSAI (i.e., first association). These one or more Mapped S-NSSAIs may be S-NSSAIs of another PLMN (the HPLMN of the UE 1) that is different from the PLMN to which the AMF 2 belongs. In the first association, at least one Mapped S-NSSAI subject to NSSAA and at least one Mapped S-NSSAI not subject to NSSAA are both associated with one Serving PLMN S-NSSAI.

In step 402, the AMF 2 receives a Registration Request message from the UE 1 containing information indicating whether the UE 1 supports the NSSAA feature. Based on this information, the AMF 2 identifies (or determines) Mapped S-NSSAI(s) to be associated with a Serving PLMN S-NSSAI. More specifically, the AMF 2 may determine whether or not the UE 1 supports the NSSAA feature based on 5GMM Capability information regarding NSSAA contained in the received Registration Request message. The 5GMM Capability information about NSSAA indicates whether the UE 1 supports the NSSAA feature. The 5GMM Capability information about NSSAA may be an NSSAA value included in the 5GMM Capability information. The NSSAA value is an example of information indicating whether NSSAA feature is supported. The AMF 2 may recognize that the UE 1 does not support the NSSAA feature if the NSSAA value indicates “Network slice-specific authentication and authorization not supported” or if the NSSAI value is not included in the 5GMM Capability information. The AMF 2 then refers to the first association between the Serving PLMN S-NSSAI and multiple Mapped S-NSSAIs, and identifies (or selects) the Serving PLMN S-NSSAI and at least one Mapped S-NSSAI associated with that Serving PLMN S-NSSAI and not subject to NSSAA. In addition, the AMF2 identifies (or selects), from the first association, the Serving PLMN S-NSSAI and at least one Mapped S-NSSAI associated with that Serving PLMN S-NSSAI and subject to NSSAA.

In step 403, the AMF 2 sets, out of the first association, an association of the Serving PLMN S-NSSAI with at least one Mapped S-NSSAI not subject to NSSAA (i.e., the second association) into an Allowed NSSAI IE for the UE 1. In addition, the AMF 2 selects from the first association an association between the Serving PLMN S-NSSAI and at least one Mapped S-NSSAI subject to NSSAA (hereafter this association is referred to as the third association), and sets the Serving PLMN S-NSSAI corresponding to the third association in to a Rejected NSSAI IE for the UE 1. Alternatively, the AMF 2 may set into the Rejected NSSAI IE for the UE 1 the Serving PLMN S-NSSAI associated with at least one Mapped S-NSSAI subject to NSSAA, and set into the Allowed NSSAI for the UE 1 the Serving PLMN S-NSSAI and the Mapped S-NSSAI(s) that is associated with that Serving PLMN S-NSSAI and is not subject to NSSAA. The AMF 2 then sends a message containing these Allowed NSSAI IE and Rejected NSSAI IE to the UE 1. This message may be a message sent from the AMF 2 to the UE 1 to configure or update the NSSAI Storage or other UE configurations. This message may be a NAS message, or more specifically, a Registration Accept message.

In response to receiving this message, the UE 1 updates the NSSAI Storage stored in a memory of the UE 1. Specifically, the UE 1 stores the S-NSSAI(s) contained in the received Rejected NSSAI IE into the Rejected NSSAI of the NSSAI storage. In addition, the UE 1 replaces or rewrites the Allowed NSSAI in the NSSAI storage with the (Serving PLMN) S-NSSAI(s) contained in the received Allowed NSSAI IE. Furthermore, the UE 1 deletes or removes all the Mapped S-NSSAIs stored in the Allowed NSSAI of the NSSAI storage and then stores the Mapped S-NSSAI(s) associated with the S-NSSAI(s) in the received Allowed NSSAI IE, i.e., here the Mapped S-NSSAI(s) not subject to NSSAA, in the Allowed NSSAI.

FIG. 5 shows an example of the procedure for updating the NSSAI Storage. In step 501, the Configured NSSAI in the NSSAI Storage of the UE1 stores Home PLMN S-NSSAIs (here S-NSSAI #1, 5-NSSAI #2). In step 502, the UE 1 sends a Registration Request message to the AMF 2. The AMF 2 may be an AMF in a Visited PLMN (VPLMN). The UE 1 includes S-NSSAI #1 and S-NSSAI #2 into a Requested mapped NSSAI IE contained in this Registration Request message, based on the stored Configured NSSAI. In addition, the Registration Request message indicates that the UE 1 does not support NSSAA. Specifically, the Registration Request message contains a 5GMM Capability IE set to “Network slice-specific authentication and authorization not supported”.

In step 503, the AMF 2 submits a resource request regarding the Subscribed NSSAI of the UE 1 using a Get operation to the SDM service exposed by the UDM 8. The request may be made, for example, via a Nudm_SDM_Get API. In step 504, the UDM 8 returns the Subscribed NSSAI (here S-NSSAI #1, S-NSSAI #2) of the UE 1 to the AMF 2, including it in the message body of a message with the status code 200 OK. The subscribed NSSAI has an AdditionalSnssaiData attribute (or field). This field indicates whether or not each S-NSSAI is subject to NSSAA. Specifically, the field contains a list of attribute (e.g., requiredAuthnAuthz) values, each of which indicates whether or not the corresponding S-NSSAI is subject to NSSAA. More specifically, the attribute value for S-NSSAI #1 indicates that S-NSSAI #1 is not subject to NSSAA (e.g., requiredAuthnAuthz=false or absent), while the attribute value for S-NSSAI #2 indicates that 5-NSSAI #2 is subject to NSSAA (e.g., requiredAuthnAuthz=true).

In step 505, the AMF 2 has associated a specific Serving PLMN S-NSSAI (here S-NSSAI #3) that the AMF 2 supports (or can serve) with S-NSSAI #1 and S-NSSAI #2. That is, two Mapped S-NSSAIs (5-NSSAI #1, S-NSSAI #2) are associated with S-NSSAI #3. The selection of a specific Serving PLMN S-NSSAI to be associated with S-NSSAI #1 and S-NSSAI #2 may be performed by the NSSF, for example. Specifically, after step 504, the AMF 2 may send S-NSSAI #1 and 5-NSSAI #2 to the NSSF. Upon receipt of S-NSSAI #1 and S-NSSAI #2, the NSSF may associate S-NSSAI #1 and S-NSSAI #2 with a specific Serving PLMN S-NSSAI (in this case S-NSSAI #3) (i.e., first association) and may send this first association to the AMF 2. The NSSF may send Configured NSSAI including this first association to the AMF 2.

In step 506, the AMF 2 determines a Rejected NSSAI IE and an Allowed NSSAI IE to be sent to the UE 1 based on the NSSAA value in the 5GMM Capability information indicating that the UE 1 does not support NSSAA (“Network slice-specific authentication and authorization not supported”). Specifically, the AMF 2 sets 5-NSSAI #3 in the Rejected NSSAI IE. In addition, the AMF 2 sets, in the Allowed NSSAI IE, a combination (or second association) of 5-NSSAI #3 and a Mapped S-NSSAI(s) (here, S-NSSAI #1) associated with S-NSSAI #3 and not subject to NSSAA. In addition to this, the AMF 2 may determine a Configured NSSAI IE to be sent to the UE 1. In the example in FIG. 5, the AMF 2 sets, in the Configured NSSAI IE, a combination (or second association) of S-NSSAI #3 and a Mapped S-NSSAI(s) (here S-NSSAI #1) associated with S-NSSAI #3 and not subject to NSSAA, and a combination (or third association) of 5-NSSAI #3 and a Mapped S-NSSAI(s) (here S-NSSAI #2) associated with S-NSSAI #3 and subject to NSSAA. The AMF 2 sends a NAS message (e.g., Registration Accept message) containing these Rejected NSSAI IE, Allowed NSSAI IE, and Configured NSSAI IE to the UE 1.

In step 507, upon receiving the NAS message, the UE 1 updates the NSSAI Storage stored in a memory of the UE 1. Specifically, the UE 1 replaces or overwrites the Allowed NSSAI in the NSSAI storage by the S-NSSAI(s) included in the received Allowed NSSAI IE. In addition, the UE 1 deletes or removes all the Mapped S-NSSAIs stored in the Allowed NSSAI of the NSSAI storage and then stores the Mapped S-NSSAI(s) associated with the S-NSSAI(s) in the received Allowed NSSAI IE, i.e., here the Mapped S-NSSAI(s) not subject to NSSAA. Furthermore, the UE 1 deletes or removes all the S-NSSAIs stored in the Configured NSSAI of the NSSAI storage and then stores the S-NSSAI(s) contained in the received Configured NSSAI IE. Alternatively, the UE 1 replaces or rewrites the Configured NSSAI in the NSSAI storage with the S-NSSAI(s) included in the received Configured NSSAI IE. Furthermore, the UE1 adds the S-NSSAI(s) contained in the received Rejected NSSAI IE to the Rejected NSSAI in the NSSAI storage.

As a variation of the second embodiment, all of the Subscribed NSSAI (here S-NSSAI #1, S-NSSAI #2) of the UE 1 managed by the UDM 8 may be subject to NSSAA. Specifically, the Subscribed NSSAI contains a list of attribute values (requiredAuthnAuthz=true) indicating that S-NSSAI #1 and S-NSSAI #2 are subject to NSSAA.

In this case, the AMF 2 sets S-NSSAI #3 to the Rejected NSSAI IE if the UE 1 does not support NSSAA. In addition, the AMF 2 sets, in the Configured NSSAI IE, the combination of S-NSSAI #3 and each of the Mapped S-NSSAIs (here S-NSSAI #1 and S-NSSAI #2) associated with S-NSSAI #3 and subject to NSSAA. The AMF 2 sends a Registration Accept message or a Registration Reject message including these Configured NSSAI IE and Rejected NSSAI IE to the UE 1.

The procedure in this embodiment updates the configuration (NSSAI Storage) in the UE 1 based on an association indicating an available Home PLMN slice service(s) (or Mapped S-NSSAI(s)) in roaming scenarios and on information indicating that an unavailable Home PLMN slice service(s) is associated with a Serving PLMN S-NSSAI. This allows the UE 1 to properly select available slice services.

For example, in a roaming scenario, one Serving PLMN S-NSSAI may be associated with both a Mapped S-NSSAI(s) (or HPLMN S-NSSAI(s)) subject to NSSAA and a Mapped S-NSSAI(s) (or HPLMN S-NSSAI(s)) not subject to NSSAA. In this case, if the UE 1 does not support NSSAA, the AMF 2 in the Serving PLMN updates the Allowed NSSAI and Rejected NSSAI in the NSSAI Storage of the UE 1 in a Registration procedure, thereby adding the second association described above (i.e., the association of the Serving PLMN S-NSSAI and with the Mapped S-NSSAI(s) not subject to NSSAA) to the Allowed NSSAI, and adding this Serving PLMN S-NSSAI to the Rejected NSSAI. Based on the fact that the Allowed NSSAI and the Rejected NSSAI contain the same Serving PLMN S-NSSAI and the Allowed NSSAI contains the Mapped S-NSSAI(s) associated with that Serving PLMN S-NSSAI, the UE 1 is able to determine that both disallowed Mapped S-NSSAI(s) (here Mapped S-NSSAI(s) subject to NSSAA) and allowed Mapped S-NSSAI(s) (here Mapped S-NSSAI(s) not subject to NSSAA) are associated with this same Serving PLMN S-NSSAI. Thus, the UE 1 can avoid setting the disallowed Mapped S-NSSAI(s) in Registration Request messages in subsequent registration procedures. Regarding a Protocol Data Unit (PDU) Session establishment, even if the same Serving PLMN S-NSSAI is included in the Allowed NSSAI and the Rejected NSSAI, as mentioned above, the UE 1 is still able to set the Serving PLMN S-NSSAI and the allowed Mapped S-NSSAI(s) (here Mapped S-NSSAI(s) not subject to NSSAA) to the PDU Session Establishment Request message based on the Allowed NSSAI.

### Third Embodiment

This embodiment provides a modification to the second embodiment. A configuration example of a radio communication network according to this embodiment may be the same as the example shown in FIG. 1.

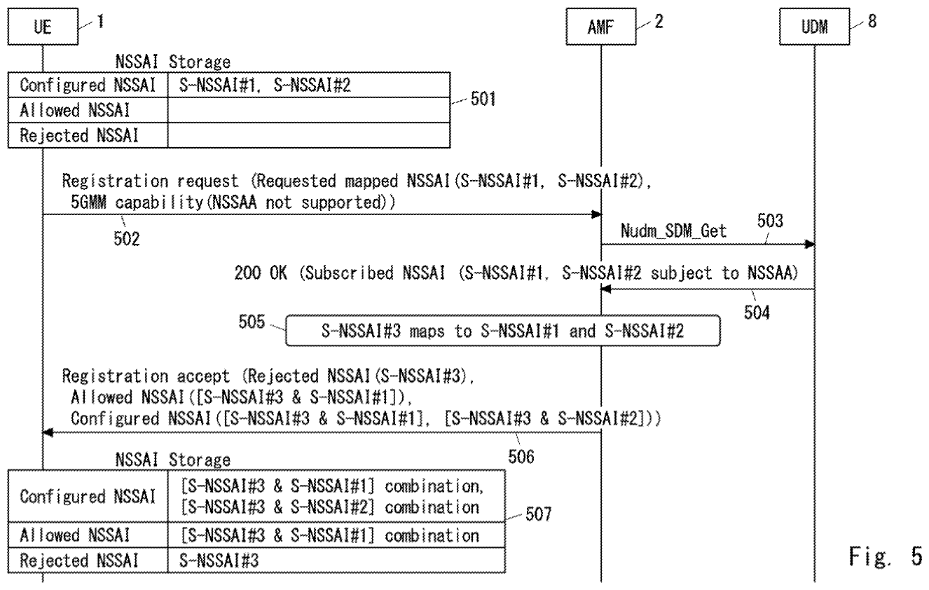

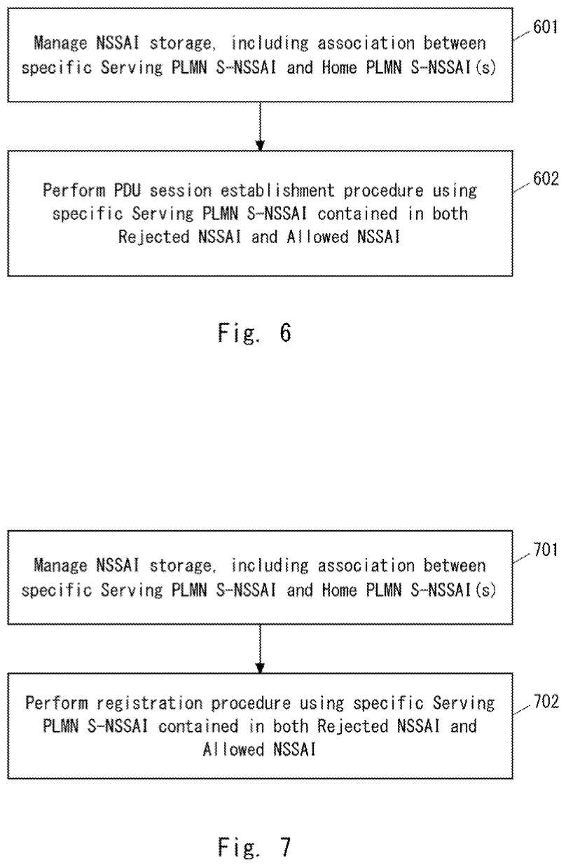

FIG. 6 is a flowchart showing an example of the operation of the UE 1 in this embodiment. In step 601, the UE 1 manages Configured NSSAI, Allowed NSSAI, and Rejected NSSAI in its NSSAI Storage. The Configured NSSAI contains a combination of a first Serving PLMN S-NSSAI and a first Mapped S-NSSAI(s) associated with the first Serving PLMN S-NSSAI, and a combination of the first Serving PLMN S-NSSAI and a second Mapped S-NSSAI(s) associated with the first Serving PLMN S-NSSAI. The Allowed NSSAI contains the combination of the first Serving PLMN S-NSSAI and the first Mapped S-NSSAI(s) associated with the first Serving PLMN S-NSSAI. The Rejected NSSAI contains the first Serving PLMN S-NSSAI. The first Mapped S-NSSAI(s) may be S-NSSAI(s) not subject to NSSAA, while the second Mapped S-NSSAI(s) may be S-NSSAI(s) subject to NSSAA.

In step 602, the UE 1 sends a message to the network to establish a Protocol Data Unit (PDU) Session, using the first Serving PLMN S-NSSAI contained in both the Rejected NSSAI and the Allowed NSSAI. The UE 1 may set the first Serving PLMN S-NSSAI and the first Mapped S-NSSAI(s) associated with the first Serving PLMN S-NSSAI into the message for PDU Session establishment. Although the first Serving PLMN S-NSSAI is included in the Rejected NSSAI in the NSSAI Storage, it is also included in the Allowed NSSAI in the NSSAI Storage, so the UE 1 can recognize that the combination of the first Serving PLMN S-NSSAI and the first Mapped S-NSSAI(s) is available for a PDU Session establishment.

More specifically, if the first Serving PLMN S-NSSAI is included in both the Allowed NSSAI and the Rejected NSSAI and is associated with a specific Mapped S-NSSAI(s) (here the first Mapped S-NSSAI(s)) in the Allowed NSSAI, the UE 1 can recognize that the first Serving PLMN S-NSSAI is associated with multiple Mapped S-NSSAIs, and determine that the association with the first Mapped S-NSSAI(s) indicated in the Allowed NSSAI can be used to establish a PDU Session. Accordingly, the UE 1 may set the first Serving PLMN S-NSSAI and the first Mapped S-NSSAI(s) associated therewith into a message for PDU Session establishment request and send it to the network. This message for establishing a PDU Session may be a NAS message, and more specifically a UL NAS Transport message containing a PDU Session establishment request message.

The network (i.e., AMF 2) receives the UL NAS Transport message from the UE 1 containing the first Serving PLMN S-NSSAI and the first Mapped S-NSSAI(s) associated therewith. The network then determines whether the Allowed NSSAI in the UE context managed by the AMF 2 stores an association between the first Serving PLMN S-NSSAI and a particular Mapped S-NSSAI(s) (in this case, the first Mapped S-NSSAI(s)). The network processes the UL NAS Transport message based on the result of that decision. Specifically, if the Allowed NSSAI in the UE context managed by the AMF 2 contains an association between the Mapped S-NSSAI(s) and the Serving PLMN S-NSSAI indicated in the UL NAS Transport message, then the AMF 2 proceeds with the PDU Session establishment procedure.

On the other hand, if the Allowed NSSAI in the UE context managed by the AMF 2 does not contain an association between the Mapped S-NSSAI(s) and the Serving PLMN S-NSSAI indicated in the UL NAS Transport message, then the AMF 2 returns to the UE 1 a DL NAS Transport message indicating that the UL NAS Transport message has been rejected. In this way, the AMF 2 notifies the UE 1 that the Mapped S-NSSAI(s) (or the combination of Mapped S-NSSAI(s) and Serving PLMN S-NSSAI) configured in the UL NAS Transport message is not available in the PLMN. The DL NAS Transport message may include a cause such as “S-NSSAI not acceptable”, “S-NSSAI not available”, “S-NSSAI not valid in PLMN”, etc., to indicate to the UE 1 that the S-NSSAI(s) configured in the UL NAS Transport message is not appropriate. Upon receiving the DL NAS Transport message containing a cause indicating that the S-NSSAI(s) configured in the UL NAS Transport message is inappropriate, the UE 1 may manage the combination of the Mapped S-NSSAI(s) and the Serving PLMN S-NSSAI(s) in question as Rejected NSSAI and recognize that it is not available in the PLMN.

### Fourth Embodiment

This embodiment provides a modification to the second embodiment. A configuration example of a radio communication network according to this embodiment may be the same as the example shown in FIG. 1.

FIG. 7 is a flowchart showing an example of the operation of the UE 1 in this embodiment. In step 701, the UE 1 manages Configured NSSAI, Allowed NSSAI, and Rejected NSSAI in its NSSAI Storage. The Configured NSSAI contains a combination of a first Serving PLMN S-NSSAI and a first Mapped S-NSSAI(s) associated with the first Serving PLMN S-NSSAI, and a combination of the first Serving PLMN S-NSSAI and a second Mapped S-NSSAI(s) associated with the first Serving PLMN S-NSSAI. The Allowed NSSAI contains the combination of the first Serving PLMN S-NSSAI and the first Mapped S-NSSAI(s) associated with the first Serving PLMN S-NSSAI. The Rejected NSSAI contains the first Serving PLMN S-NSSAI. The first Mapped S-NSSAI(s) may be S-NSSAI(s) not subject to NSSAA, while the second Mapped S-NSSAI(s) may be S-NSSAI(s) subject to NSSAA.

In step 702, the UE 1 performs a subsequent registration procedure using the first Serving PLMN S-NSSAI included in both the Rejected NSSAI and the Allowed NSSAI. The UE 1 may set the first Serving PLMN S-NSSAI and the first Mapped S-NSSAI(s) associated with the first Serving PLMN S-NSSAI into a message for the registration procedure. Although the first Serving PLMN S-NSSAI is included in the Rejected NSSAI in the NSSAI Storage, it is also included in the Allowed NSSAI in the NSSAI Storage, so the UE 1 can recognize that the combination of the first Serving PLMN S-NSSAI and the first Mapped S-NSSAI(s) is available for a registration procedure.

More specifically, if the first Serving PLMN S-NSSAI is included in both the Allowed NSSAI and the Rejected NSSAI and is associated with a specific Mapped S-NSSAI(s) (here the first Mapped S-NSSAI(s)) in the Allowed NSSAI, the UE 1 can recognize that the first Serving PLMN S-NSSAI is associated with multiple Mapped S-NSSAIs, and determine that the association with the first Mapped S-NSSAI(s) indicated in the Allowed NSSAI is available for a registration procedure. Accordingly, the UE 1 may set the first Serving PLMN S-NSSAI and the first Mapped S-NSSAI(s) associated therewith into a message for a registration procedure and send it to the network. This message for a registration procedure may be a NAS message, more specifically a Registration Request message for Mobility Registration Update or Periodic Registration Update.

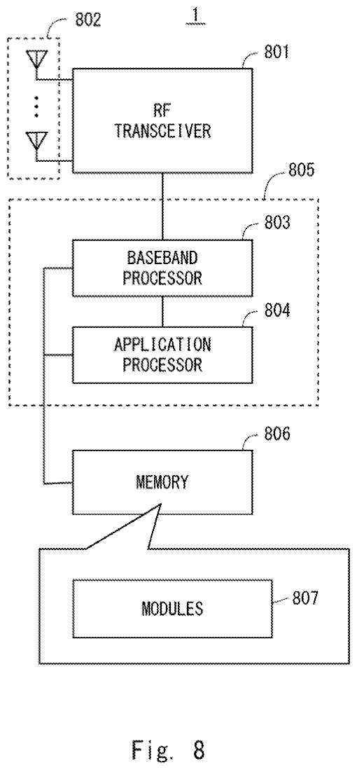

The following provides configuration examples of the UE 1, the AMF 2, and the UDM 8 according to the above-described embodiments. FIG. 8 is a block diagram showing an example configuration of the UE 1. A Radio Frequency (RF) transceiver 801 performs analog RF signal processing to communicate with RAN nodes. The RF transceiver 801 may include a plurality of transceivers. The analog RF signal processing performed by the RF transceiver 801 includes frequency up-conversion, frequency down-conversion, and amplification. The RF transceiver 801 is coupled to an antenna array 802 and a baseband processor 803. The RF transceiver 801 receives modulated symbol data (or OFDM symbol data) from the baseband processor 803, generates a transmission RF signal, and supplies the transmission RF signal to the antenna array 802. Further, the RF transceiver 801 generates a baseband reception signal based on a reception RF signal received by the antenna array 802 and supplies the baseband reception signal to the baseband processor 803. The RF transceiver 801 may include an analog beamformer circuit for beam forming. The analog beamformer circuit includes, for example, a plurality of phase shifters and a plurality of power amplifiers.

The baseband processor 803 performs digital baseband signal processing (i.e., data-plane processing) and control-plane processing for radio communication. The digital baseband signal processing includes (a) data compression/decompression, (b) data segmentation/concatenation, (c) composition/decomposition of a transmission format (i.e., transmission frame) (d) channel coding/decoding, (e) modulation (i.e., symbol mapping)/demodulation, and (f) generation of OFDM symbol data (i.e., baseband OFDM signal) by Inverse Fast Fourier Transform (IFFT). Meanwhile, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

The digital baseband signal processing by the baseband processor 803 may include, for example, signal processing of Service Data Adaptation Protocol (SDAP), Packet Data Convergence Protocol (PDCP), Radio Link Control (RLC), Medium Access Control (MAC), and Physical (PHY) layers. The control-plane processing performed by the baseband processor 803 may include processing of Non-Access Stratum (NAS) protocols, Radio Resource Control (RRC) protocols, and MAC Control Elements (CEs). The baseband processor 803 may perform Multiple Input Multiple Output (MIMO) encoding and pre-coding for beam forming.

The baseband processor 803 may include a modem processor (e.g., Digital Signal Processor (DSP)) that performs the digital baseband signal processing and a protocol stack processor (e.g., a Central Processing Unit (CPU) or a Micro Processing Unit (MPU)) that performs the control-plane processing. In this case, the protocol stack processor, which performs the control-plane processing, may be integrated with an application processor 804 described in the following.

The application processor 804 is also referred to as a CPU, an MPU, a microprocessor, or a processor core. The application processor 804 may include a plurality of processors (or processor cores). The application processor 804 loads a system software program (Operating System (OS)) and various application programs (e.g., a call application, a WEB browser, a mailer, a camera operation application, and a music player application) from a memory 806 or from another memory (not shown) and executes these programs, thereby providing various functions of the UE 1.

In some implementations, as represented by a dashed line (805) in FIG. 8, the baseband processor 803 and the application processor 804 may be integrated on a single chip. In other words, the baseband processor 803 and the application processor 804 may be implemented in a single System on Chip (SoC) device 805. The SoC device may be referred to as a Large-Scale Integration (LSI) or a chipset.

The memory 806 is a volatile memory, a non-volatile memory, or a combination thereof. The memory 806 may include a plurality of memory devices that are physically independent from each other. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 806 may include, for example, an external memory device that can be accessed from the baseband processor 803, the application processor 804, and the SoC 805. The memory 806 may include an internal memory device that is integrated in the baseband processor 803, the application processor 804, or the SoC 805. Further, the memory 806 may include a memory in a Universal Integrated Circuit Card (UICC).

The memory 806 may store one or more software modules (computer programs) 807 including instructions and data to perform the processing by the UE 1 described in the above embodiments. In some implementations, the baseband processor 803 or the application processor 804 may load these software modules 807 from the memory 806 and execute the loaded software modules, thereby performing the processing of the UE 1 described in the above embodiments with reference to the drawings.

The control-plane processing and operations performed by the UE 1 described in the above embodiments can be achieved by elements other than the RF transceiver 801 and the antenna array 802, i.e., achieved by the memory 806, which stores the software modules 807, and one or both of the baseband processor 803 and the application processor 804.

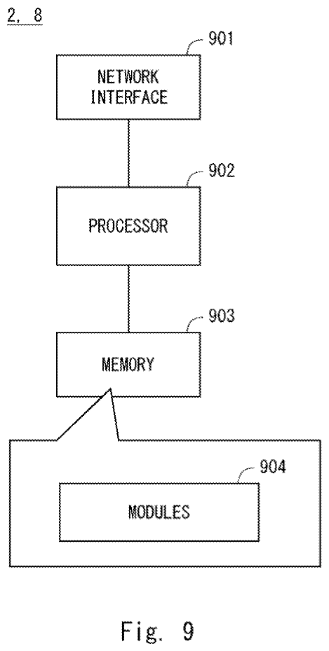

FIG. 9 shows an example configuration of the AMF 2. The UDM 8 may also have the configuration shown in FIG. 9. Referring to FIG. 9, the AMF 2 includes a network interface 901, a processor 902, and a memory 903. The network interface 901 is used to communicate with, for example, (R)AN nodes and with other network functions (NFs) or nodes in the 5GC. The other NFs or nodes in the 5GC include, for example, UDM, AUSF, SMF, and PCF. The network interface 901 may include, for example, a network interface card (NIC) conforming to the IEEE 802.3 series.

The processor 902 may be, for example, a microprocessor, a Micro Processing Unit (MPU), or a Central Processing Unit (CPU). The processor 902 may include a plurality of processors.

The memory 903 is composed of a volatile memory and a nonvolatile memory. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 903 may include a storage located apart from the processor 902. In this case, the processor 902 may access the memory 903 via the network interface 901 or an I/O interface.

The memory 903 may store one or more software modules (computer programs) 904 including instructions and data to perform the processing of the AMF 2 described in the above embodiments. In some implementations, the processor 902 may be configured to load the one or more software modules 904 from the memory 903 and execute the loaded software modules, thereby performing the processing of the AMF 2 described in the above embodiments.

The User Equipment (UE) in the present disclosure is an entity to be connected to a network via a wireless interface. It should be noted that the radio terminal (UE) in the present disclosure is not limited to a dedicated communication device, and it may be any device as follows having the communication functions herein explained.

The terms “User Equipment (UE)” (as the term is used by 3GPP), “mobile station”, “mobile terminal”, “mobile device”, and “radio terminal (wireless device)” are generally intended to be synonymous with one another. The UE may include standalone mobile stations, such as terminals, cell phones, smartphones, tablets, cellular IoT (internet of things) terminals, and IoT devices. It will be appreciated that the terms “UE” and “radio terminal” also encompass devices that remain stationary for a long period of time.

A UE may be, for example, a device for production or manufacture and/or energy (e.g., a boiler, engine, turbine, solar panel, wind turbine, hydroelectric generator, thermal power generator, nuclear electricity generator, battery, nuclear system and/or associated devices, heavy electrical machinery, pump or vacuum pump, compressor, fan, blower, oil hydraulic device, pneumatic device, metal working machinery, manipulator, robot and/or its application systems, tool, mold or die, roll, conveying device, elevating device, materials handling device, textile machinery, sewing machine, printing and/or related machinery, paper making machinery, chemical machinery, mining and/or construction machinery and/or related devices, agriculture, forestry and/or fisheries machinery and/or implements, safety and/or environment preservation device, tractor, bearing, precision bearing, chain, gear, power transmission device, lubricator, valve, pipe fitting, and/or application system for any of the previously mentioned devices or machinery, etc.).

A UE may be, for example, a device for transport (e.g., a vehicle, automobile, motorcycle, bicycle, train, bus, cart; rickshaw, ship and other watercraft, aircraft, rocket, satellite, drone, balloon, etc.).

A UE may be, for example, a device for information and communication (e.g., a computers and related devices, communication device and related devices, electronic component, etc.).

A UE may be, for example, a refrigeration device, refrigeration application product and device, trade and/or service industry device, vending machine, automatic service machine, office machine or device, consumer electronic and electronic appliance (e.g., audio device, speaker, radio, video devices, television, oven range, rice cooker, coffee maker, dishwasher, washing machine, dryer, fan, exhaust fan and related products, vacuum cleaner, etc.).

A UE may be, for example, an electrical application system or an electronic application device (e.g., an x-ray device, particle accelerator, radioactive material application device, sound wave application device, electromagnetic application device, power application device, etc.).

A UE may be, for example, a light bulb, lighting device, weighing machine, analytical instrument, testing and measuring machine (e.g., a smoke alarm, human alarm sensor, motion sensor, wireless tag, etc.), watch or clock, physical or chemical machine, optical machine, medical device and/or medical system, weapon, sharp-edged tool, hand tool, or the like.

A UE may be, for example, a personal digital assistant or device with wireless communication capabilities (e.g., an electronic device (e.g., a personal computer or electronic measuring instrument) configured to be attached or inserted with a wireless card or wireless module).

A UE may be a device or a part of a system that provides applications, services, and solutions described below, as to “internet of things (IoT)”, using a variety of wired and/or wireless communication technologies. Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked. It will be appreciated that IoT technology can be implemented on any communication devices that can connect to a communications network for sending/receiving data, regardless of whether such communication devices are controlled by human input or software instructions stored in memory. It will be appreciated that IoT devices are sometimes also referred to as Machine-Type Communication (MTC) devices, Machine-to-Machine (M2M) communication devices, or Narrow Band-IoT (NB-IoT) UE.

The UE may support one or more IoT or MTC applications.

Some examples of MTC applications are listed in 3GPP TS 22.368 V13.2.0 (2017 Jan. 13), Annex B (the contents of which are incorporated herein by reference). This list is not exhaustive and is intended to be indicative of some examples of MTC applications. In this list, the Service Area of the MTC applications includes security, tracking & tracing, payment, health, remote maintenance/control, metering, and consumer devices.

Examples of the MTC applications regarding security include surveillance systems, backup for landline telephone, control of physical access (e.g., to buildings), and car/driver security.

Examples of the MTC applications regarding tacking & tracing include fleet management, order management, telematics insurance: pay as you drive (PAYD), asset tracking, navigation, traffic information, road tolling, and road traffic optimisation/steering.

Examples of the MTC applications regarding payment include point of sales (POS), vending machines, and gaming machines.

Examples of the MTC applications regarding Health include Monitoring vital signs, Supporting the aged or handicapped, Web Access Telemedicine points, and Remote diagnostics.

Examples of the MTC applications regarding remote maintenance/control include sensors, lighting, pumps, valves, elevator control, vending machine control, and vehicle diagnostics.

Examples of the MTC applications regarding metering include power, gas, water, heating, grid control, and industrial metering.

Examples of the MTC applications regarding consumer devices include digital photo frame, digital camera, and ebook.

Applications, services, and solutions may be an mobile virtual network operator (MVNO) service/system, an emergency radio communication service/system, a private branch exchange (PBX) service/system, a PHS/digital cordless telecommunications service/system, a point of sale (POS) service/system, an advertise calling service/system, a Multimedia Broadcast and Multicast Service (MBMS) service/system, a Vehicle to Everything (V2X) service/system, a train radio service/system, a location related service/system, a disaster/emergency wireless communication service/system, an Internet of Things (IoT) service/system, a community service/system, a video streaming service/system, a femto cell application service/system, a Voice over LTE (VoLTE) service/system, a radio tag service/system, a charging service/system, a radio on demand service/system, a roaming service/system, an activity monitoring service/system, a telecom carrier/communication NW selection service/system, a functional restriction service/system, a proof of concept (PoC) service/system, a personal information management service/system, a display video service/system, a non-communication service/system, an ad-hoc network/delay tolerant networking (DTN) service/system, etc.

The above-described UE categories are merely examples of applications of the technical ideas and embodiments described in the present disclosure. The UE described in this disclosure is not limited to these examples and various modifications can be made thereto by those skilled in the art.

The above-described aspects are merely examples of applications of the technical ideas obtained by the inventors. These technical ideas are not limited to the above-described embodiments and various modifications can be made thereto.

The whole or part of the embodiments disclosed above can be described as, but not limited to, the following supplementary notes.
(Supplementary Note 1)
   A core network node comprising:
   at least one memory; and
   at least one processor coupled to the at least one memory and configured to:
      store a first association between a plurality of Home Public Land Mobile Network (PLMN) Single Network Slice Selection Assistance Information (S-NSSAIs) and one Serving PLMN S-NSSAI,
         wherein the first association includes a second association between the one Serving PLMN S-NSSAI and at least one Home PLMN S-NSSAI that is not subject to Network Slice-Specific Authentication and Authorization (NSSAA), and a third association between the one Serving PLMN S-NSSAI and at least one Home PLMN S-NSSAI subject to NSSAA;
   receive information indicating whether an NSSAA feature is supported from a User Equipment (UE); and
   if the information indicates that the NSSAA feature is not supported, and if a part of multiple Home PLMN S-NSSAIs presented by the UE is included in the second association and the rest is included in the third association, send information including the second association out of the first association to the UE.
(Supplementary Note 2)
   The core network node according to Supplementary Note 1, wherein the at least one processor is configured to send to the UE a Non-Access Stratum (NAS) message containing a Configured NSSAI that includes the second association and does not include the third association.
(Supplementary Note 3)
   The core network node according to Supplementary Note 2, wherein NAS message further includes an Allowed NSSAI that includes the second association and does not include the third association.
(Supplementary Note 4)
   The core network node according to Supplementary Note 1, wherein the at least one processor is configured to send to the UE a NAS message containing an Allowed NSSAI and a Rejected NSSAI,
   wherein the Allowed NSSAI includes the second association and does not include the third association, and
   wherein the Rejected NSSAI includes the one Serving PLMN S-NSSAI included in both the second and third associations.
(Supplementary Note 5)
   The core network node according to Supplementary Note 4, wherein the NAS message further includes a Configured NSSAI that includes both the second and third associations.
(Supplementary Note 6)
   The core network node according to any one of Supplementary Notes 1 to 5, wherein the information indicating whether the NSSAA feature is supported is included in a Registration Request message.
(Supplementary Note 7)
   The core network node according to Supplementary Note 1, wherein the at least one processor is configured to, if the information indicates that the NSSAA feature is not supported and one or more Home PLMN S-NSSAIs presented by the UE are all included in the third association, send a NAS message to the UE, the NAS message containing a Rejected NSSAI that includes the one Serving PLMN S-NSSAI included in the third association and a Configured NSSAI containing the third association.
(Supplementary Note 8)
   A User Equipment (UE) comprising:
   at least one memory; and
   at least one processor coupled to the at least one memory and configured to:
      send information to a core network node indicating whether a Network Slice-Specific Authentication and Authorization (NSSAA) feature is supported;
      receive a Non-Access Stratum (NAS) message from the core network node,
         wherein if the information indicates that the NSSAA feature is not supported, the NAS message contains a second association of one Serving Public Land Mobile Network (PLMN) Single Network Slice Selection Assistance Information (S-NSSAI) with at least one first Home PLMN S-NSSAI not subject to NSSAA and contains a third association of the one Serving PLMN S-NSSAI with at least one second Home PLMN S-NSSAI subject to NSSAA; and
      based on the second and third associations, update a stored NSSAI storage to make the at least one first Home PLMN S-NSSAI included in the second association available and to make the at least one second Home PLMN S-NSSAI included in the third association unavailable.
(Supplementary Note 9)
   The UE according to Supplementary Note 8, wherein if the information indicates that the NSSAA feature is not supported, the NAS message contains a Configured NSSAI containing the second association of the one Serving PLMN S-NSSAI with the at least one first Home PLMN S-NSSAI not subject to NSSAA, and
   wherein the at least one processor is configured to update, with the second association contained in the Configured NSSAI, a Configured NSSAI contained in the stored NSSAI storage.
(Supplementary Note 10)
   The UE according to Supplementary Note 8 or 9, wherein if the information indicates that the NSSAA feature is not supported, the NAS message contains an Allowed NSSAI containing the second association of the one Serving PLMN S-NSSAI with the at least one first Home PLMN S-NSSAI not subject to NSSAA, and also contains a Rejected NSSAI containing the one Serving PLMN S-NSSAI, and
   wherein the at least one processor is configured to:
      update, with the second association contained in the Allowed NSSAI, an Allowed NSSAI contained in the stored NSSAI storage; and
      update, with the one Serving PLMN S-NSSAI contained in the Rejected NSSAI, a Rejected NSSAI contained in the stored NSSAI storage.
(Supplementary Note 11)
   The UE according to any one of Supplementary Notes 8 to 10, wherein the NAS message is a registration accept message.
(Supplementary Note 12)
   The UE according to Supplementary Note 8, wherein if the information indicates that the NSSAA feature is not supported, the NAS message contains a Configured NSSAI containing the third association of the one Serving PLMN S-NSSAI with the at least one second Home PLMN S-NSSAI subject to NSSAA, and also contains a Rejected NSSAI containing the one Serving PLMN S-NSSAI, and
   wherein the at least one processor is configured to:
      update, with the third association contained in the Configured NSSAI, a Configured NSSAI contained in the stored NSSAI storage; and
      update, with the one Serving PLMN S-NSSAI contained in the Rejected NSSAI, a Rejected NSSAI contained in the stored NSSAI storage.
(Supplementary Note 13)
   The UE according to any one of Supplementary Notes 8 to 12, wherein the at least one processor is configured to send a message to the core network node to establish a Protocol Data Unit (PDU) Session associated with the one Serving PLMN S-NSSAI and the at least one first Home PLMN S-NSSAI included in the second association.
(Supplementary Note 14)
   The UE according to any one of Supplementary Notes 8 to 13, wherein the at least one processor is configured to, in a procedure for registering the UE to a Serving PLMN, send to a registration request message the core network node, the registration request message including the one Serving PLMN S-NSSAI and the at least one first Home PLMN S-NSSAI, included in the second association, in at least a Requested NSSAI.
(Supplementary Note 15)
   A method performed by a core network node, the method comprising:
   storing a first association between a plurality of Home Public Land Mobile Network (PLMN) Single Network Slice Selection Assistance Information (S-NSSAIs) and one Serving PLMN S-NSSAI,
      wherein the first association includes a second association between the one Serving PLMN S-NSSAI and at least one Home PLMN S-NSSAI that is not subject to Network Slice-Specific Authentication and Authorization (NSSAA), and a third association between the one Serving PLMN S-NSSAI and at least one Home PLMN S-NSSAI subject to NSSAA;
   receiving information indicating whether an NSSAA feature is supported from a User Equipment (UE); and
   if the information indicates that the NSSAA feature is not supported, and if a part of multiple Home PLMN S-NSSAIs presented by the UE is included in the second association and the rest is included in the third association, sending information including the second association out of the first association to the UE.
(Supplementary Note 16)
   A method performed by a User Equipment (UE), the method comprising:
   sending information to a core network node indicating whether a Network Slice-Specific Authentication and Authorization (NSSAA) feature is supported;
   receiving a Non-Access Stratum (NAS) message from the core network node,
      wherein if the information indicates that the NSSAA feature is not supported, the NAS message contains a second association of one Serving Public Land Mobile Network (PLMN) Single Network Slice Selection Assistance Information (S-NSSAI) with at least one first Home PLMN S-NSSAI not subject to NSSAA and contains a third association of the one Serving PLMN S-NSSAI with at least one second Home PLMN S-NSSAI subject to NSSAA; and
   based on the second and third associations, updating a stored NSSAI storage to make the at least one first Home PLMN S-NSSAI included in the second association available and to make the at least one second Home PLMN S-NSSAI included in the third association unavailable.

This application is based upon and claims the benefit of priority from Japanese Patent Application No. 2020-167941, filed on Oct. 2, 2020, the disclosure of which is incorporated herein in its entirety by reference.

### REFERENCE SIGNS LIST

1 UE
2 AMF
3 SMF
4 AUSF
5 AN
6 UPF
7 DN
8 UDM
803 Baseband Processor
804 Application Processor
806 Memory
807 Modules
902 Processor
903 Memory
904 Modules

What is claimed is:

1. A core network node comprising:
at least one memory; and
at least one processor coupled to the at least one memory and configured to:
store a first association between a plurality of Home Public Land Mobile Network (PLMN) Single Network Slice Selection Assistance Information (S-NSSAIs) and one Serving PLMN S-NSSAI,
wherein the first association includes a second association between the one Serving PLMN S-NSSAI and at least one Home PLMN S-NSSAI that is not subject to Network Slice-Specific Authentication and Authorization (NSSAA), and a third association between the one Serving PLMN S-NSSAI and at least one Home PLMN S-NSSAI subject to NSSAA;
receive information indicating whether an NSSAA feature is supported from a User Equipment (UE); and
if the information indicates that the NSSAA feature is not supported, and if a part of multiple Home PLMN S-NSSAIs presented by the UE is included in the second association and the rest is included in the third association, send information including the second association out of the first association to the UE.

2. The core network node according to claim 1, wherein the at least one processor is configured to send to the UE a Non-Access Stratum (NAS) message containing a Configured NSSAI that includes the second association and does not include the third association.

3. The core network node according to claim 2, wherein NAS message further includes an Allowed NSSAI that includes the second association and does not include the third association.

4. The core network node according to claim 1, wherein the at least one processor is configured to send to the UE a NAS message containing an Allowed NSSAI and a Rejected NSSAI,
wherein the Allowed NSSAI includes the second association and does not include the third association, and
wherein the Rejected NSSAI includes the one Serving PLMN S-NSSAI included in both the second and third associations.

5. The core network node according to claim 4, wherein the NAS message further includes a Configured NSSAI that includes both the second and third associations.

6. The core network node according to claim 1, wherein the information indicating whether the NSSAA feature is supported is included in a Registration Request message.

7. The core network node according to claim 1, wherein the at least one processor is configured to, if the information indicates that the NSSAA feature is not supported and one or more Home PLMN S-NSSAIs presented by the UE are all included in the third association, send a NAS message to the UE, the NAS message containing a Rejected NSSAI that includes the one Serving PLMN S-NSSAI included in the third association and a Configured NSSAI containing the third association.

8. A User Equipment (UE) comprising:
at least one memory; and
at least one processor coupled to the at least one memory and configured to:
send information to a core network node indicating whether a Network Slice-Specific Authentication and Authorization (NSSAA) feature is supported;
receive a Non-Access Stratum (NAS) message from the core network node,
wherein if the information indicates that the NSSAA feature is not supported, the NAS message contains a second association of one Serving Public Land Mobile Network (PLMN) Single Network Slice Selection Assistance Information (S-NSSAI) with at least one first Home PLMN S-NSSAI not subject to NSSAA and contains a third association of the one Serving PLMN S-NSSAI with at least one second Home PLMN S-NSSAI subject to NSSAA; and
based on the second and third associations, update a stored NSSAI storage to make the at least one first Home PLMN S-NSSAI included in the second association available and to make the at least one second Home PLMN S-NSSAI included in the third association unavailable.

9. The UE according to claim 8, wherein if the information indicates that the NSSAA feature is not supported, the NAS message contains a Configured NSSAI containing the second association of the one Serving PLMN S-NSSAI with the at least one first Home PLMN S-NSSAI not subject to NSSAA, and
wherein the at least one processor is configured to update, with the second association contained in the Configured NSSAI, a Configured NSSAI contained in the stored NSSAI storage.

10. The UE according to claim 8, wherein if the information indicates that the NSSAA feature is not supported, the NAS message contains an Allowed NSSAI containing the second association of the one Serving PLMN S-NSSAI with the at least one first Home PLMN S-NSSAI not subject to NSSAA, and also contains a Rejected NSSAI containing the one Serving PLMN S-NSSAI, and
wherein the at least one processor is configured to:
update, with the second association contained in the Allowed NSSAI, an Allowed NSSAI contained in the stored NSSAI storage; and
update, with the one Serving PLMN S-NSSAI contained in the Rejected NSSAI, a Rejected NSSAI contained in the stored NSSAI storage.

11. The UE according to claim 8, wherein the NAS message is a registration accept message.

12. The UE according to claim 8, wherein if the information indicates that the NSSAA feature is not supported, the NAS message contains a Configured NSSAI containing the third association of the one Serving PLMN S-NSSAI with the at least one second Home PLMN S-NSSAI subject to NSSAA, and also contains a Rejected NSSAI containing the one Serving PLMN S-NSSAI, and
wherein the at least one processor is configured to:
update, with the third association contained in the Configured NSSAI, a Configured NSSAI contained in the stored NSSAI storage; and
update, with the one Serving PLMN S-NSSAI contained in the Rejected NSSAI, a Rejected NSSAI contained in the stored NSSAI storage.

13. The UE according to claim 8, wherein the at least one processor is configured to send a message to the core network node to establish a Protocol Data Unit (PDU) Session associated with the one Serving PLMN S-NSSAI and the at least one first Home PLMN S-NSSAI included in the second association.

14. The UE according to claim 8, wherein the at least one processor is configured to, in a procedure for registering the UE to a Serving PLMN, send to a registration request message the core network node, the registration request message including the one Serving PLMN S-NSSAI and the at least one first Home PLMN S-NSSAI, included in the second association, in at least a Requested NSSAI.

15. A method performed by a core network node, the method comprising:
storing a first association between a plurality of Home Public Land Mobile Network (PLMN) Single Network Slice Selection Assistance Information (S-NSSAIs) and one Serving PLMN S-NSSAI,
wherein the first association includes a second association between the one Serving PLMN S-NSSAI and at least one Home PLMN S-NSSAI that is not subject to Network Slice-Specific Authentication and Authorization (NSSAA), and a third association between the one Serving PLMN S-NSSAI and at least one Home PLMN S-NSSAI subject to NSSAA;
receiving information indicating whether an NSSAA feature is supported from a User Equipment (UE); and
if the information indicates that the NSSAA feature is not supported, and if a part of multiple Home PLMN S-NSSAIs presented by the UE is included in the second association and the rest is included in the third association, sending information including the second association out of the first association to the UE.

16. (canceled)
